(19) United States
(12) Patent Application Publication
(10) Pub. No.: US 2005/0047491 A1
(43) Pub. Date: Mar. 3, 2005

(54) Method and apparatus for improving channel estimate based on short synchronization code

(76) Inventor: Haitao Zhang, San Diego, CA (US)

Correspondence Address: Qualcomm Incorporated;Patents Department, 5775 Morehouse Drive, San Diego, CA, 92121-1714, US

(21) Appl. No.: 10/650,272

(22) Filed: Aug. 28, 2003

(51) Int. Cl. H04B 1/707

(52) U.S. Cl. 375/150

(57) ABSTRACT

A method and apparatus for estimating a communication channel impulse response h(t) is disclosed. The method comprises the steps of generating coₘ(t)=co(t+mNT_{c}) for m=0, 1, Λ, M by correlating a received signal r(t) with a spreading sequence Sᵢ of length N, wherein the received signal r(t) comprises a chip sequence cⱼ applied to a communication channel characterizable by an impulse response h(t), and wherein the chip sequence Cⱼ is generated from a data sequence dᵢ spread by the spreading sequence Sᵢ; generating an estimated communication channel impulse response ĥ_{M}(t) as a combination of coₘ(t) and dₘ for m=0, 1, Λ, M; and filtering the first estimated communication channel impulse response ĥ_{M}(t) to generate the estimated communication channel impulse response h(t) with a filter f selected at least in part according to the spreading sequence Sᵢ.

### CROSS-REFERENCE TO RELATED APPLICATIONS

This application is related to the following co-pending and commonly assigned patent application(s), all of which applications are incorporated by reference herein:

application Ser. No. ______, entitled “METHOD AND APPARATUS FOR REMOVING CODE ALIASES WHEN USING SHORT SYNCHRONIZATION CODES,” filed on same date herewith, by Haitao Zhang, attorney's docket number 020305.

### BACKGROUND OF THE INVENTION

1. Field of the Invention

The present invention relates to systems and methods for communicating information, and in particular to a system and method for estimating the impulse response of a communication channel using short synchronization codes.

2. Description of the Related Art

In packet-based communication systems, spreading codes are used for packet detection and synchronization purposes. Correlation techniques are used to identify and synchronize to its timing. In many instances, the spreading code sequence can be in the order of 1000 chips or more. Since the receiver must correlate through all possible delays, this process can result in unacceptable delays.

To ameliorate this problem, a short spreading code with good aperiodic autocorrelation can be used for packet detection and synchronization purposes. One example is the IEEE 802.11 Wireless Local Area Network (WLAN) system, which uses a length 11 Barker code as a spreading sequence for the preamble and the header of a packet. The short length of the spreading sequence makes it easy for receivers to quickly detect the presence of a packet in the communication channel and to synchronize to its timing.

In the case of a linear channel, for the purpose of receiver design, it is often desirable to estimate the impulse response of the communication channel. In the context of the WLAN, a multi-path linear channel is often utilized, and such communication channels require equalization for effective reception. Given an estimate of the impulse response of the communication channel, we can directly calculate equalizer coefficients through matrix computations, as opposed to the conventional adaptive algorithms. This is described in “Digital Communications,” by John G. Proakis, 4th edition, Aug. 15, 2000, which reference is hereby incorporated by reference herein. This allows equalizer coefficients to be computed in a digital signal processor (DSP) instead of in more expensive and less adaptable dedicated hardware implementing the adaptation algorithms.

Unfortunately, because the spreading code used is short (e.g. on the order of 11 symbols) a straightforward correlation using the spreading code will produce a distorted estimate. What is needed is a simple, computationally efficient technique that can be used to compute substantially undistorted communication channel impulse response estimates, even when the received signal was chipped with a short spreading code. The present invention satisfies that need.

### SUMMARY OF THE INVENTION

To address the requirements described above, the present invention discloses a method and apparatus for estimating a communication channel impulse response h(t). The method comprises the steps of generating coₘ(t)=co(t+mNT_{c}) for m=0, 1, Λ, M by correlating a received signal r(t) with a spreading sequence Sᵢ of length N, wherein the received signal r(t) comprises a chip sequence c, applied to a communication channel characterizable by an impulse response h(t), and wherein the chip sequence cⱼ is generated from a data sequence dᵢ spread by the spreading sequence Sᵢ; generating an estimated communication channel impulse response ĥ_{M}(t) as a combination of coₘ(t) and dₘ for m=0, 1, Λ, M; and filtering the first estimated communication channel impulse response ĥ_{M}(t) to generate the estimated communication channel impulse response h(t) with a filter f selected at least in part according to the spreading sequence Sᵢ. The apparatus comprises a correlator for generating coₘ(t)=co(t+mNT_{c}) for m=0, 1, Λ, M by correlating a received signal r(t) with a spreading sequence Sᵢ of length N, wherein the received signal r(t) comprises a chip sequence Cⱼ applied to a communication channel characterizable by an impulse response h(t), and wherein the chip sequence Cⱼ is generated from a data sequence dᵢ spread by the spreading sequence Sᵢ; an estimator for generating an estimated communication channel impulse response ĥ_{M}(t) as a combination of coₘ(t) and dₘ for m=0, 1, Λ, M; and a filter f selected at least in part according to the spreading sequence Sᵢ, the filter for filtering the first estimated communication channel impulse response ĥ_{M}(t) to generate the estimated communication channel impulse response ĥ(t).

The foregoing permits the impulse response ĥ(t) of the communication channel to be accurately estimated, even with short chip codes. Non-intuitively, in the case of a time-limited channel impulse response, the present invention yields an estimate that can be made perfect in the limit of high signal-to-noise ratio (SNR).

### BRIEF DESCRIPTION OF THE DRAWINGS

Referring now to the drawings in which like reference numbers represent corresponding parts throughout:

FIG. 1 is a diagram of a transceiver system;

FIG. 2 is a block diagram illustrating process steps that can be used to implement the present invention;

FIG. 3 is a diagram of a transceiver system utilizing a filter f to improve the estimated communication channel impulse response;

FIG. 4 is a diagram showing the response of the filter;

FIG. 5 is a flowchart describing exemplary processing steps that can be used to improve the reconstruction of the value of the communication channel impulse response using super codes imposed on the portion of the data sequence;

FIG. 6 is a diagram of a transceiver system utilizing super code to transmit sequences;

FIG. 7 is a diagram presenting a correlator output using 11 symbol long Barker code;

FIG. 8 is a diagram presenting a correlator output using Walsh codes as an input super code;

FIG. 9 is a diagram presenting a correlator output after postprocessing with a filter f as described in FIG. 2 and FIG. 3;

FIG. 10 is a diagram presenting a more detailed view of the main lobe peak, showing the estimate of the communication channel impulse response in the actual communications channel impulse response; and

FIG. 11 is a diagram presenting one embodiment of a processor that can be used to practice the present invention.

### DETAILED DESCRIPTION OF PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### System Model

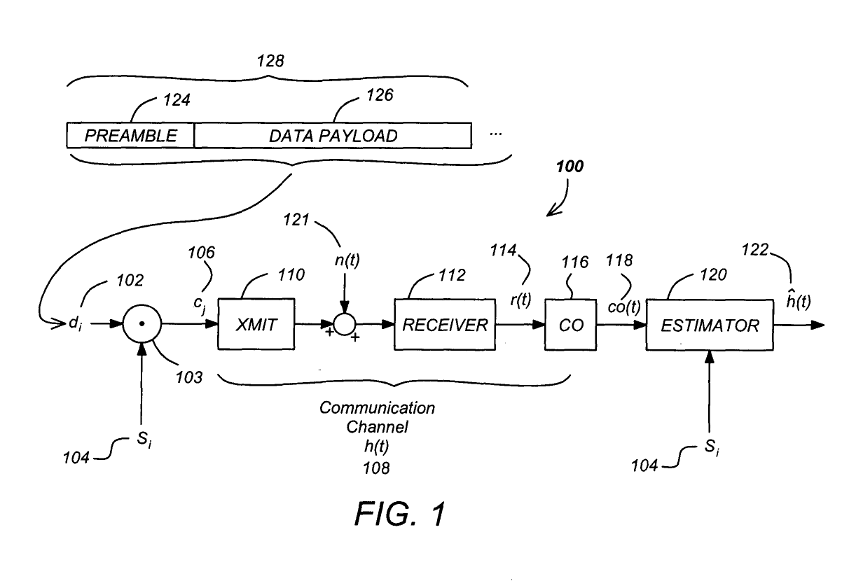

FIG. 1 is a diagram of a transceiver system 100. Using signal spreader 103, a random data symbol sequence dᵢ 102, comprising a series of data packets 128 (each of which may include a preamble 124 used by the receiver for identification purposes, as well as a data payload 126) is spread by a sequence Sᵢ 104 of length N: {Sₙ, 0≦,i≦N−1} and having a chip period. The sequence Sᵢ 104 is known to the receiver 112 apriori. The spread chip sequence cⱼ 106 is therefore:
cⱼ=c_{iN+n}=dᵢ•Sₙ, 0≦n≦N−1 Eq. (1)

This spread chip sequence Cⱼ 106 is transmitted through a linear transmission channel 108 having a combined channel impulse response h(t). The transmitted signal is received by a receiver 112. The received waveform r(t) 114 is:

$$r ( t ) = {\sum }_{j = - ∞}^{∞} {c}_{j} • h ( t - j {T}_{c} ) + n ( t ) \qquad Eq . ( 2 )$$

where n(t) 121 is an additive noise component.

This formulation does not explicitly impose a causality requirement on h(t) 108. If explicit causality is desired, this can be accomplished by setting h(t)=0, t<0. For simplicity purposes, all the data and code sequences in the following discussion are assumed to be real, though the channel impulse response h(t) 108 and the additive noise component n(t) 121 could be complex in their baseband representations. Complex sequences could be easily accommodated if needed, but they are not common for synchronization purposes.

The receiver 112 receives the transmitted signal, and correlates the received signal r(t) 114 with the known spreading sequence Sᵢ 104 to identify the data as intended to be received by the receiver 112. Once the received signal r(t) 114 is received, the preamble can be examined to determine the address of the data and whether further processing is necessary.

Such systems also use the received signal to estimate the input response of the communication channel 108. This information is used to improve later detection and reception of signals from the transmitter 110. In circumstances where the spreading sequence Sᵢ 104 is relatively short, the data packet 128 must be detected quickly, and there is less data available to estimate the response of the communication channel 108. Conventional Detection and Synchronization

For detection and synchronization purposes, the search for the spreading code is conventionally performed by correlating the received signal r(t) 114 with the spreading sequence. This is accomplished by the correlator 116. Although this correlation is typically done after sampling in the time domain, for notational simplicity, we do not perform the time domain discretization. The correlator 116 output co(t) 118 is given by:

$$\begin{matrix}co ( t ) = {\sum }_{i = 0}^{N - 1} r ( t + ( N - 1 ) {T}_{c} - i {T}_{c} ) • {S}_{N - i - 1} & Eq . ( 3 ) \\ = {\sum }_{i = 0}^{N - 1} r ( t + i {T}_{c} ) • {S}_{i} & Eq . ( 4 ) \\ = {\sum }_{i = 0}^{N - 1} {\sum }_{j = - ∞}^{∞} {c}_{j} • h ( t - ( j - i ) {T}_{c} ) • {S}_{i} + \tilde{n} ( t ) & Eq . ( 5 ) \\ = {\sum }_{l = - ∞}^{∞} {\sum }_{i = 0}^{N - 1} {c}_{l + i} • {S}_{i} • h ( t - l {T}_{c} ) + \tilde{n} ( t ) & Eq . ( 6 ) \\ = {\sum }_{l = - ∞}^{∞} D ( l ) • h ( t - l {T}_{c} ) + \tilde{n} ( t ) & Eq . ( 7 )\end{matrix}$$

where D(l) is the correlation between the chip sequence and the spreading sequence and we will refer to it as the chip correlation.

For notational simplicity, we have introduced a (negative) group delay (IT_{c}) in calculating the correlator output 118. The correlator 116 output is given by the convolution of the chip correlation D(l) with the sampled communication channel impulse response h(t−lT_{c}) plus a noise component n (t). Upon further examination:

$$\begin{matrix}D ( l ) = {\sum }_{i = 0}^{N - 1} {c}_{l + i} • {S}_{i} & Eq . ( 8 ) \\ = {\sum }_{i = 0}^{N - 1 - n} {d}_{m} • {S}_{n + i} • {S}_{i} + {\sum }_{i = N - n}^{N - 1} {d}_{m + 1} • {S}_{n + i - N} • {S}_{i} & Eq . ( 9 ) \\ = {d}_{m} • A ( n ) + {d}_{m + 1} • A ( N - n ) , & Eq . ( 10 ) \\ l = mN + n , 0 \leq n < N & Eq . ( 11 )\end{matrix}$$

=dₘ•A(n)+dₘ+1•A(N−n), Eq. (10)
l=mN+n,0≦n≦N Eq. (11)
where A(n) is a two-sided aperiodic autocorrelation of the spreading sequence defined as:

$$A ( n ) = A ( - n ) = {\sum }_{i = 0}^{N - 1 - n} {S}_{i} • {S}_{i + n} , 0 \leq n < N \\ A ( n ) = 0 , \vert n \vert \geq N \qquad Eq . ( 12 )$$

A(n) is a property of the code sequence that is known by the correlator 116 apriori.

For detection and synchronization purposes, the spreading sequence Sᵢ 104 is designed to have minimum values of A(k) when k≠0. However, for small (e.g. on the order of 10) values of N (short spreading codes), even the smallest side lobe magnitude is not negligible compared to the in-phase autocorrelation.

Barker sequences, when they exist, give the best aperiodic autocorrelation. For an 11 chip Barker sequence, Sᵢ =1, −1, 1, 1, −1, 1, 1, 1, −1, −1, −1, the autocorrelation becomes A(i)=11, 0, −1, 0, −1, 0, −1, 0, −1, 0, −1 for 0≦i<11. Note that even for Barker codes, because the spreading sequence Sᵢ 104 is of limited length, the autocorrelation A(i) includes significant side lobes.

The correlator 116 output 118 can be rewritten as:

$$\begin{matrix}co ( t ) = {\sum }_{j = - ∞}^{∞} {\sum }_{i = 0}^{N - 1} D ( j N + i ) • h ( t - ( j N + i ) {T}_{c} ) + \tilde{n} ( t ) & Eq . ( 13 ) \\ = {\sum }_{j = - ∞}^{∞} {\sum }_{i = 0}^{N - 1} ( {d}_{j} • A ( i ) + {d}_{j + 1} • A ( N - i ) ) • & Eq . ( 14 ) \\ h ( t - ( j N + i ) {T}_{c} ) + \tilde{n} ( t ) & \\ = {\sum }_{j = - ∞}^{∞} {\sum }_{i = 0}^{N - 1} {d}_{j} • ( A ( i ) • h ( t - ( j N + i ) {T}_{c} ) + A ( N - i ) • & Eq . ( 15 ) \\ h ( t - ( ( j - 1 ) N + i ) {T}_{c} ) ) + \tilde{n} ( t ) & \\ = {\sum }_{j = - ∞}^{∞} {\sum }_{i = - N + 1}^{N - 1} {d}_{j} • A ( i ) • h ( t - j {NT}_{c} - {iT}_{c} ) + \tilde{n} ( t ) & Eq . ( 16 ) \\ = {\sum }_{j = - ∞}^{∞} {d}_{j} • \hat{h} ( t - j {NT}_{c} ) + \tilde{n} ( t ) & Eq . ( 17 )\end{matrix}$$

where the following is defined as the convolution of the spreading sequence aperiodic autocorrelation A(i) and the sampled channel impulse response h(t−iT_{c}) as follows:

$$\hat{h} ( t ) = {\sum }_{i = - N + 1}^{N - 1} A ( i ) • h ( t - {iT}_{c} ) \qquad Eq . ( 18 )$$

This is an estimate of the combined communication channel 108 impulse response ĥ(t) at the output of the code correlator 116.

The above equations can be more succinctly written using a convolutional notation. Defining a convolution of two infinite sequences Aᵢ and Bᵢ as

$$C = A ⊗ B ⇔ C ( i ) = {\sum }_{j} A ( j ) • B ( i - j ) , ∀ i \qquad Eq . ( 19 )$$

By defining an operator

$${{O}^{ι}}^{T}$$

that converts any sequence O to a time domain function using the Dirac delta function:

$${{B}^{ι}}^{T} ( t ) ≡ {\sum }_{i} B ( i ) • δ ( t - iT ) \qquad Eq . ( 20 )$$

we can also define the convolution of a function with a sequence using a normal convolution of two functions:

$$C ( t ) = A ( t ) ⊗ {{B}^{ι}}^{T} ⇔ C ( t ) = {\sum }_{j} A ( t - j T ) B ( j ) \qquad Eq . ( 21 )$$

Using the above notations and further, by adopting the following definitions:
u(iN)=dᵢ(data) Eq. (22A)
u(iN+n)=0,0<n<N Eq. (22B)

$$S ( n ) = \{ \begin{matrix}{S}_{n} , & 0 \leq n < N \\ 0 , & otherwise\end{matrix} \\ \text{(a time-limited chipping sequence)} \qquad Eq . ( 22 C )$$

the foregoing equations (1), (2), (3), (6), (12), (18), (16), (17) can be rewritten as:
c=u\mathring{×}S Eq. (1′)

$$\begin{matrix}c = u ⊗ S & \text{Eq.} ( {1}^{′} ) \\ r = h {⊗}_{C}^{{τ}_{{T}_{c}}} + {n}_{o} & \text{Eq.} ( {2}^{′} ) \\ co = r ⊗ {{S}^{ι}}_{-}^{{T}_{c}} & \text{Eq.} ( {3}^{′} ) \\ = h {⊗}_{C}^{{τ}_{{T}_{c}}} ⊗ {{S}^{ι}}_{-}^{{T}_{c}} + \tilde{n} , where {S}_{-} ( n ) = S ( - n ) & \text{Eq.} ( {6}^{′} ) \\ A = S ⊗ {S}_{-} & \text{Eq.} ( {12}^{′} ) \\ \hat{h} = h ⊗ {{A}^{ι}}^{{T}_{c}} & \text{Eq.} ( {18}^{′} ) \\ co = \hat{h} {⊗}_{u}^{{τ}_{{T}_{c}}} + \tilde{n} & \text{Eq.} ( {16}^{′} ) \\ = \hat{h} ⊗ {{d}^{ι}}^{{NT}_{c}} + \tilde{n} & \text{Eq.} ( {17}^{′} )\end{matrix}$$

Determining a Communication Channel Impulse Response Estimate

For simplicity of notation, in the remaining discussion, we assume that data symbols are binary. The results however, can be generally applied to non-binary data.

Because the correlator 116 has access to the same code sequence Sᵢ 104 that was used to generate the spread chip sequence cⱼ 106 before transmission, the correlator 116 can correlate the received signal r(t) 114 with the code sequence Sᵢ 104. However, aliasing can occur with short code sequences Sᵢ 104, because time delays may cause the correlator 116 to correlate different portions of adjacent code sequences. Conventionally, these aliasing effects are reduced by integrating or summing over multiple (e.g. M) code periods, as discussed below.

As described in Eqs. (13)-(17), based on the correlator 116 output 118 we can form an estimate of the channel impulse response over one code period T_{c}:

$$\begin{matrix}{\hat{h}}_{1} ( t ) = {d}_{0} • co ( t ) \\ = \hat{h} ( t ) + {\sum }_{j \neq 0} {d}_{0} • {d}_{j} • \hat{h} ( t - {jNT}_{c} ) + {d}_{0} • \hat{n} ( t )\end{matrix} \qquad Eq . ( 23 )$$

where d₀ is a value of the data at time t=0.

This is a rough approximation to ĥ(t), corrupted by aliased copies of ĥ(t) spaced at multiples of NT_{c}, away from the desired copy. These aliasing and the additive noise terms can be reduced through further summation over M code periods:

$$\begin{matrix}{\hat{h}}_{M} ( t ) = \frac{1}{M} {\sum }_{m = 0}^{M - 1} {d}_{m} • co ( t + {mNT}_{c} ) & Eq . ( 24 ) \\ = \hat{h} ( t ) + \frac{1}{M} {\sum }_{m = 0}^{M - 1} {\sum }_{j \neq m} {d}_{m} • {d}_{j} • \hat{h} ( t + ( m - j ) {NT}_{c} ) + & Eq . ( 25 ) \\ {\tilde{n}}_{M}^{′} ( t ) & \\ = \hat{h} ( t ) + \frac{1}{M} {\sum }_{l \neq 0} {\sum }_{m = 0}^{M - 1} {d}_{m} • {d}_{l + m} • \hat{h} ( t - {lNT}_{c} ) + {\tilde{n}}_{M}^{′} ( t ) & Eq . ( 26 )\end{matrix}$$

The foregoing indicates that through output 122 of estimator 120, by removing the data modulation through correlation with the data sequence, we obtain an estimate ĥ of the channel impulse response plus terms defined by the autocorrelation of the data sequence, which vanish when summed over infinite terms.

If D_{M}(l) is defined as:

$$\begin{matrix}{D}_{M} ( l ) = \frac{1}{M} {\sum }_{m = 0}^{M - 1} {d}_{m} • {d}_{l + m} then & Eq . ( 27 ) \\ {\hat{h}}_{M} = \hat{h} ⊗ {{D}^{ι}}_{M}^{{NT}_{c}} + {\tilde{n}}_{M}^{′} & Eq . ( 28 )\end{matrix}$$

wherein ĥ_{M} is an estimate of the communication channel impulse response h(t). When the data sequence dᵢ 102 is random, white and independent of the additive noise n(t) 121, and in the limit of M→∞:

$${D}_{∞} ( l ) = {δ}_{l0} , {\tilde{n}}_{∞}^{′} = 0 \\ {\hat{h}}_{∞} = \hat{h} \qquad Eqs . ( 29 )$$

Therefore, in the limit of infinite summation (as M approaches infinity), we obtain an estimate that is equal to the true channel impulse response h(t) convolved with the aperiodic autocorrelation of the spreading sequence Sᵢ 104.

As the foregoing demonstrates, we can not obtain the true channel impulse response h(t) with simple integration. The best we have is smeared by the autocorrelation of the spreading sequence Sᵢ 104. In cases where the spreading sequence Sᵢ 104 is long, the autocorrelation approaches a delta function, and the side lobes disappear. However, when the spreading sequence Sᵢ 104 is short, the sidelobes of the autocorrelation are not negligible and will cause significant distortion to the estimate of the communication channel impulse response h(t).

Improved Channel Estimates for Short Spreading Sequences

As is demonstrated below, the present invention improves the communication channel impulse response estimate by filtering the first estimated communication channel impulse response ĥ_{M}(t) to generate the estimated communication channel impulse response h(t) with a filter f selected at least in part according to the spreading sequence Sᵢ. In particular, when the time span of the communication channel 108 is limited, a zero-forcing deconvolution can be used to improve the estimate.

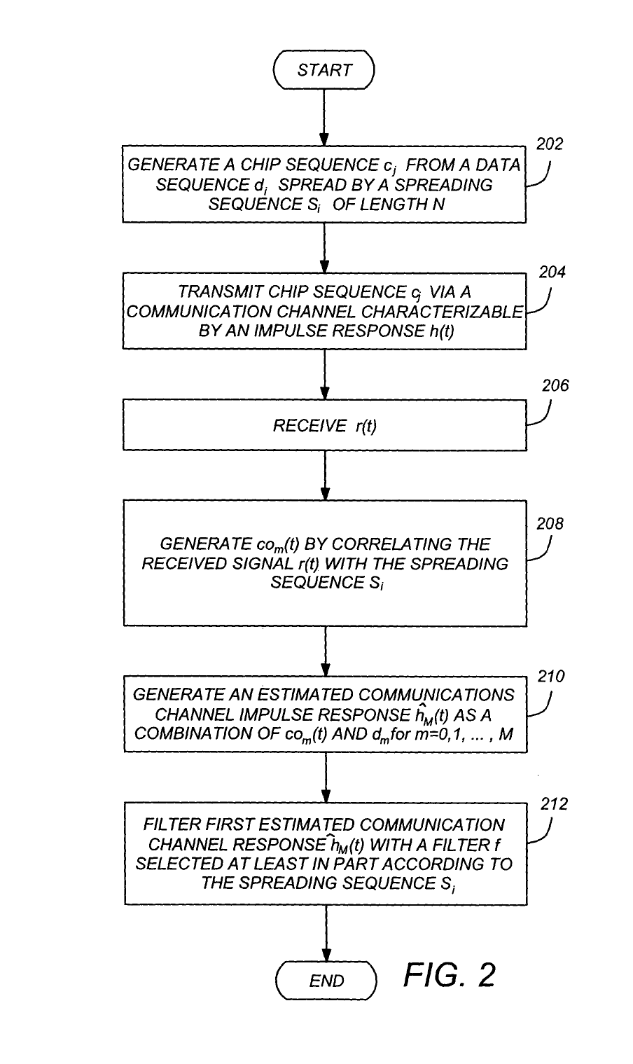

FIG. 2 is a block diagram illustrating process steps that can be used to implement the present invention.

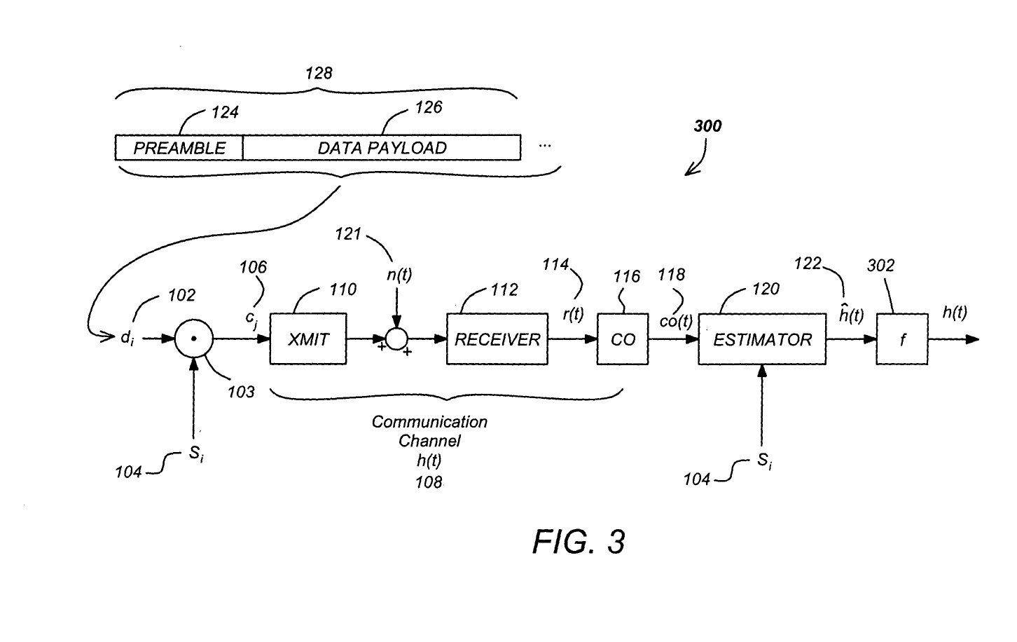

FIG. 3 is a diagram of a transceiver system 300 utilizing the filter f described above to filter the first estimated communication channel impulse response ĥ_{M}(t) to generate an improved estimate suitable for short spreading sequences Sᵢ 104.

Referring to FIG. 2 and FIG. 3, blocks 202 through 208 recite steps that are used to generate coₘ(t) 118. A spread chip sequence Cⱼ 106 is generated from a data symbol sequence dᵢ 102 and a spreading sequence Sᵢ 104 of length N, as shown in block 202. The chip sequence cⱼ 106 is transmitted via a communication channel 108 as shown in block 204, and received as shown in block 206. The communication channel includes the transmitter 110 and the receiver 112. The received signal r(t) 114 is then correlated with the spreading sequence Sᵢ 104, by the correlator 116 to generate coₘ(t) as shown in block 208.

In block 210, an estimated communications channel impulse response ĥ_{M}(t) is generated by the estimator 120 as a combination of coₘ(t) and dₘ for m=0, 1, K, M This can be accomplished, for example using the relationship described in Eq. (24) above.

Finally, in block 212, the first estimated communication channel response ĥ_{M}(t) is filtered with a filter f selected at least in part according to the spreading sequence Sᵢ 104. In one embodiment, the filter is a finite impulse response (FIR) filter f 302 designed with the following constraints:
A_{f}=A\mathring{×}f Eq. (29)
A_{f}(0)=1,A_{f}(n)=0,0<|n|≦L Eq. (30)
wherein A\mathring{×}f is the convolution of the autocorrelation of the spreading sequence Sᵢ 104 and the filter, and A_{f} is the autocorrelation of the spreading sequence Sᵢ 104 after filtering.

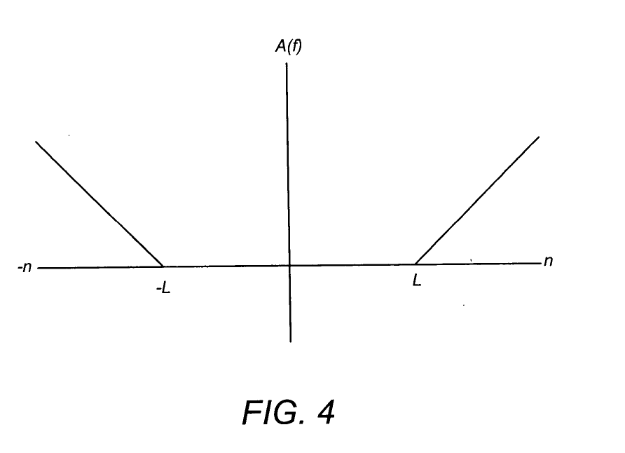

FIG. 4 is a diagram showing the response of the filter f 302 described in Eqs. (29) and (30).

When the estimate of the communication channel impulse response is filtered with this filter, we obtain:

$$\begin{matrix}{h}_{f} = \hat{h} ⊗ {{f}^{ι}}^{{T}_{c}} \\ = h ⊗ {{A}^{τ}}^{{T}_{c}} ⊗ {{f}^{τ}}^{{T}_{c}} \\ = h ⊗ {{A}^{τ}}_{f}^{{T}_{c}}\end{matrix} \qquad Eq . ( 31 )$$

Using this technique, the effects of the side lobes (aliased versions of the autocorrelation of the spreading sequence Sᵢ 104) are eliminated between L and −L. The side lobes are not completely removed (since the filter passes components greater than L and less than −L) but the result near the origin (n=0) is of primary interest, and the effect of the side lobes can be significantly reduced in this region.

If the time span (duration of the impulse response) of the communications channel is less than LT_{c}, i.e.
∃t₁<t₂,t₂₋ₜ₁<LT_{c}, ∀t<t₁∪t>t₂:h(t)≈0 Eq. (32)
(that is, there exists a time t₂ greater than t₁ defining a time interval t₂−t₁ less than LT_{c}, and for all time outside of the interval t₂−t₁, h(t) is close to zero),

Then, the filtered estimate h_{f} (or, in the earlier notation, h_{f} (t)) is composed of an exact copy of h (h(t)), plus some aliased versions of it in non-overlapping locations. So in this case h is resolvable from h_{f}.

Such a filter with length 2L+1 can be designed with the simple zero-forcing criteria:

$${\sum }_{i = - L}^{L} A ( n - i ) • f ( i ) = {A}_{f} ( n ) , - L \leq n \leq L \qquad Eq . ( 33 )$$

wherein f(i) is the impulse response of the filter f 302 such that A_{f} (n) is a convolution of A(n) and f(i), A_{f} (n)=1 for n=0 and A_{f} (n)=0 for 0<|n|≦L, and

$$A ( n ) = A ( - n ) = {\sum }_{i = o}^{N - 1 - n} {S}_{i} • {S}_{i + n} , 0 \leq n \leq N ,$$

and wherein N is a length of the chip sequence Sᵢ 104. L can be chosen such that the product LT_{c} (the chip period T_{c} is known) is approximately equal to the time span (e.g. the approximate duration of the impulse response) of the channel 108.

Note that the value A(n−i) is well defined . . . it is a property of the spreading sequence Sᵢ 104, which is known apriori.

As usual, the matrix structure of the linear equations is Toeplitz. By the design requirement of the spreading sequence Sᵢ, the matrix should be well conditioned. The filter coefficients can be computed offline given the spreading sequence and desired window width L.

While the foregoing has been described in respect to non recursive filters, other filters, such as recursive filters may also be used. A recursive filter, for example, may provide perfect filtering of the sidelobes, but the result may not be the quell conditioned matrix, hence the solution may be more difficult to determine. In fact, any filter of length 2L+1 can be defined.

### Super Coded Transmit Sequences

It has been shown that given ĥ and with filtering, it is possible to recover the true channel impulse response for a time limited channel. However, in the foregoing discussion, ĥ was obtained through integration over multiple spreading sequence periods. The number of periods we need to integrate over can be large especially if 2L≧N, since we rely on the autocorrelation of the data to suppress the aliased copies of ĥ.

In one embodiment of the present invention, supercodes, such as Walsh-like supercodes, are used to drastically reduce the amount of the integration required. This technique is especially useful in systems having sufficient a signal-to-noise ratio (SNR).

Consider a pair of length 2 Walsh codes w₀ {+1, +1} and w₁ {+1, −1}. These codes can be used to form a data sequence:

. . . +,+,+,−,−,− . . .

Any length 2-symbol length segment from this sequence can be described as either w₀ or −w₀, except for a single w₁ in the center. If this sequence is now correlated with w₁, the resulting correlation will be characterized by a single peak in the center and zeros elsewhere (except near the boundaries). Negatives of the two codes may be taken (e.g. w₀={−1,−1} and w₁={−1,+1}and/or their roles may be swapped (e.g. w₁={+1, +1} and w₀={+1,−1} with the same result. The three additional patterns thus obtained and their correlator patterns are listed below:

| | |
|---|---|
| . . . −, −, −, −, +, +, +, + . . . | −, + |
| . . . −, +, −, +, +, −, +, − . . . | +, + |
| . . . +, −, +, −, −, +, −, + . . . | −, − |

Since the following results are equivalent for all of the above patterns when the additive noise is uncorrelated at sampling points, we limit our discussion to the first data sequence (i.e. . . . +,+,+,−,−,− . . . ). In this case,
dᵢ=+1,∀l₁<i≦0 Eq. (34)
dᵢ=−1,∀l₂≧i>0 Eq. (35)

$$\begin{matrix}{\hat{h}}_{2} ( t ) = \frac{1}{2} ( {d}_{0} • co ( t ) + {d}_{1} • co ( t + {NT}_{c} ) ) & Eq . ( 36 ) \\ = \hat{h} ( t ) + {\sum }_{l \neq 0} ( {d}_{l} - {d}_{l + 1} ) • \hat{h} ( t - {lNT}_{c} ) + {\tilde{n}}_{2}^{′} ( t ) & Eq . ( 37 ) \\ = \hat{h} ( t ) + {\sum }_{l \leq {l}_{1} ⋃ l \geq {l}_{2}} ( {d}_{l} - {d}_{l + 1} ) • \hat{h} ( t - {lNT}_{c} ) + {\tilde{n}}_{2}^{′} ( t ) & Eq . ( 38 )\end{matrix}$$

If the condition that −l₁N>(2N+L)Il₂N>(2N+L) can be satisfied, ĥ can be reconstructed free of aliasing interference, and by deconvolution (aforementioned filtering technique), h can be reconstructed as well.

From the foregoing, it can be determined that a small supercode imposed on a portion of the data sequence can provide an alias free estimate of the communication channel impulse response when the channel response is time-limited. The only source of distortion from this estimate comes from the additive noise, which can be suppressed by the spreading gain times a factor of 2 (to account for the supercode). When the noise is low, such an approach is preferable over long integrations.

For moderate values of L, such code sequences can be easily embedded within a longer preamble to packet data, probably with multiple copies, without adversely affecting the spectrum properties of the transmission. In addition, when the signal to noise ratio (SNR) is low, traditional integration as outlined in the first half of this section can still be carried out on such a preamble to obtain a higher processing gain against the additive noise.

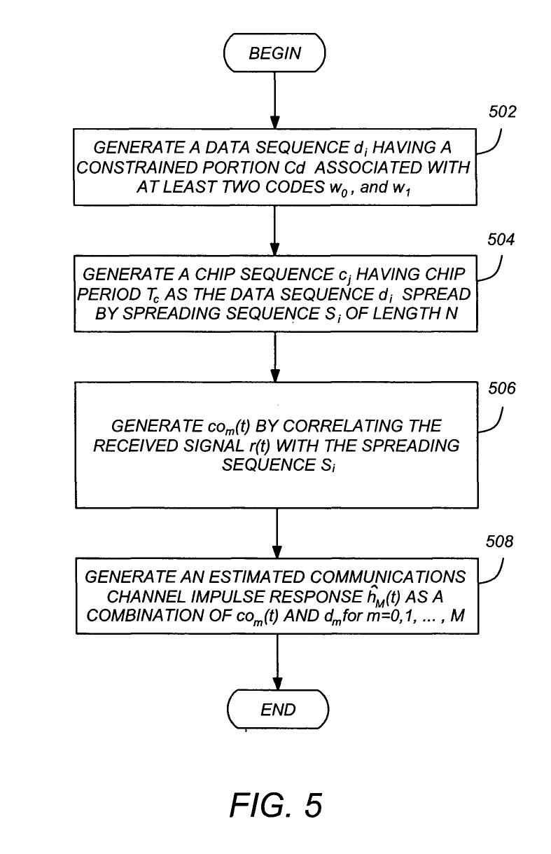

FIG. 5 is a flowchart describing exemplary processing steps that can be used to improve the reconstruction of the value of the communication channel impulse response by using supercode imposed on a portion of the data sequence.

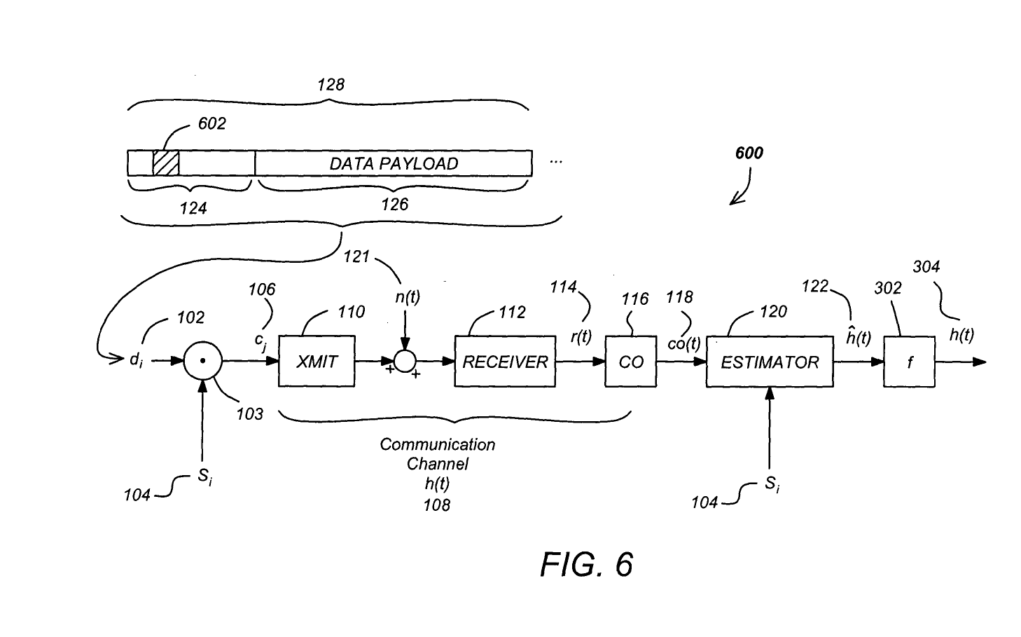

FIG. 6 is a diagram of a transceiver system 600 utilizing super coded transmit sequences to generate an improved communication channel impulse response estimate suitable for short spreading sequences Sᵢ 104.

In block 502, a data sequence dᵢ 102 is generated. The data sequenced dᵢ 102 includes one or more data packets 128, each data packet having a preamble 124 including a constrained portion Cdᵢ 602. The preamble 124, can be, for example, in the form of a pseudorandom code.

The constrained portion Cdᵢ 602 is associated with at least two codes, w₀ and w₁. The codes w₀ and w₁ are selected such that the correlation A_{code}(k) of the constrained portion Cdᵢ 602 and at least one of the codes w₀ and w₁, is characterized by a maximum value at k=0, and they value less than the maximum value at k≠0.

Ideally, the correlation A_{code}(k) of the constrained portion Cdᵢ 602 is an impulse, with A_{code}(k) equal to one at k=0, and equal at all other values for k. However, because such correlation characteristics are typically not realizable, codes w₀ and w₁ can be chosen to approximate this ideal. For example, codes w₀ and w₁ can be chosen such that the correlation A_{code}(k) of the constrained portion Cdᵢ 602 and at least one of the codes w₀ and w₁, is such that A_{code}(k)=1 at k=0 and A_{code}(k)≈0 for substantially all k ≠0. Or, codes w₀ and w₁ can be chosen such that the correlation A_{code}(k) of the constrained portion Cdᵢ 602 and at least one of the codes w₀ and w₁, is such that A_{code}(k)=0 for 0<|k|≦J wherein J is selected to minimize the correlation of the constrained portion Cdᵢ with the one of the codes w₀, w₁ for substantially all k≠0.

In one embodiment, the constrained portion Cdᵢ 602 comprises the pair of length two Walsh codes in the first sequence described above. Other embodiments are envisioned in which the codes are of another length (other than length two), or are codes other than a Walsh code.

In block 504, a chip sequence cⱼ 106 is generated. The chip sequence cⱼ 106 is generated by applying a spreading sequence Sᵢ 104 of length N and having a chip period T_{c} to the data sequence dᵢ 102.

This spread chip sequence cⱼ 106 is transmitted through a linear transmission channel 108 having a combined channel impulse response h(t). The transmitted signal is received by a receiver 112.

In block 506, the receiver 112 receives the transmitted signal, and correlates the received signal r(t) 114 with the known spreading sequence Sᵢ 104 to identify the data as intended to be received by the receiver 112. This is accomplished by generating coₘ(t)=co(t+mNT_{c}) for m=0, 1, Λ, M, using techniques analogous to those which were described above.

In block 508, an estimated communication channel impulse response ĥ_{M}(t) is generated as a combination of the correlation coₘ(t) and the data sequence dₘ for m=0, 1, Λ, M.

In one embodiment, the codes w₀ and w₁ are two symbol-long Walsh codes, and ĥ_{M}(t) computed as

$$\frac{1}{M} {\sum }_{m = 0}^{M - 1} {d}_{m} • co ( t + {mNT}_{c} ) ,$$

with M=2. In this case, ĥ_{M}(t) equals

$${\hat{h}}_{2} ( t ) = \frac{1}{2} ( {d}_{0} • co ( t ) + {d}_{1} • co ( t + {NT}_{c} ) ) .$$

Hence, where the data has been constrained with a symbol such as a Walsh super code, an improved estimate of the communications channel impulse response can be obtained by taking two consecutive values of the correlation of the received data and the spreading sequence and multiplying each result by the data sequence. In the example of Walsh codes w₀={−1, −1} and w₁ ={−1, +1} applied to the sequence . . . +,+,+,−,−,− . . . , and w₁ applied at the receiver, the result is that one of the values of co(t) is multiplied by a one, and the other is multiplied by a minus one. Hence, the output will produce essentially no response until the transition between the two Walsh codes occurs, at which time a clean, alias-free copy of the communications channel impulse response will be produced.

A length 2 supercode for improved alias suppression has been described. When the SNR is low and longer integration period is desirable, it would appear attractive to generalize the code to longer lengths. Counterintuitively, this is not possible. This result is shown below, by presenting a definition of such codes and showing that no such codes with length larger than 2 exist for binary data sequences.

An infinite sequence A forms an impulsive correlation pair with a length L finite sequence B if A satisfies the following equations:
A(i)=B(i), ∀0≦i<L

$${\sum }_{i = 0}^{L - 1} A ( i + n ) \cdot B ( i ) = 0 , ∀ n \neq 0$$

By contradiction, it can be shown that for binary sequences, such a pair does not exist for L>2. Supposing such sequences exist, it is apparent that L must be even. Considering two such cases (L=4k and L=4k+2)

In the first case, L=4k, consider the first constraint:

$$\begin{matrix}{\sum }_{i = 0}^{L - 1} A ( i - 1 ) \cdot B ( i ) = 0 , & Eq . ( 39 a ) \\ A ( - 1 ) \cdot B ( 0 ) + {\sum }_{i = 1}^{L - 1} B ( i - 1 ) \cdot B ( i ) = 0 & Eq . ( 39 b )\end{matrix}$$

Since there are 4k summands in the equation taking values from {+1, −1} half of them or 2k terms must be positive, and the other half negative. The product of all the summands must therefore be 1.

$$A ( - 1 ) \cdot B ( 0 ) \cdot {\prod }_{i = 1}^{L - 1} ( B ( i - 1 ) \cdot B ( i ) ) = 1 \\ A ( - 1 ) \cdot B ( L - 1 ) = 1 \\ A ( - 1 ) = B ( L - 1 ) \qquad Eqs . ( 40 )$$

Similar arguments can be used to show that:
A(i)=B(L+i),−L<i<0 Eq. (41)

But this implies that:

$$\begin{matrix}{\sum }_{i = 0}^{L - 1} A ( i - L ) \cdot B ( i ) = A ( - L ) \cdot B ( 0 ) + {\sum }_{i = 1}^{L - 1} A ( i - L ) \cdot B ( i ) \\ = A ( - L ) \cdot B ( 0 ) + {\sum }_{i = 1}^{L - 1} B ( i ) \cdot B ( i ) \\ = A ( - L ) \cdot B ( 0 ) + L - 1 \\ > 0\end{matrix} \qquad Eqs . ( 42 )$$

which contradicts the assumption that the cross-correlation is zero everywhere except at the origin. Hence, by contradiction, we have shown that for binary sequences, such a pair does not exist for L>2.

A similar argument can be applied for the second case, L=4k+2, except that the product of all the summands in each equations must be −1, since now we must have 2k+1 negative terms. This leads to:
A(i)=(−1)ⁱB(L+i),−L<i<0 Eq. (43)

When k>0,

$${\sum }_{i = 0}^{L - 1} A ( i - 2 ) \cdot B ( i ) = A ( - 2 ) \cdot B ( 0 ) + A ( - 1 ) \cdot B ( 1 ) + {\sum }_{i = 2}^{L - 1} A ( i - 2 ) \cdot B ( i ) \\ = B ( L - 2 ) \cdot B ( 0 ) - B ( L - 1 ) \cdot B ( 1 ) + {\sum }_{i = 2}^{L - 1} B ( i - 2 ) \cdot B ( i ) \\ = 0 \\ {\sum }_{i = 0}^{L - 1} A ( i - L + 2 ) \cdot B ( i ) = {\sum }_{i = 0}^{L - 3} A ( i - L + 2 ) \cdot B ( i ) + A ( 0 ) \cdot B ( L - 2 ) + A ( 1 ) \cdot B ( L - 1 ) \\ = {\sum }_{i = 0}^{L - 3} {( - 1 )}^{i} B ( i + 2 ) \cdot B ( i ) + B ( 0 ) \cdot B ( L - 2 ) + B ( 1 ) \cdot B ( L - 1 ) \\ = B ( L - 2 ) \cdot B ( 0 ) + B ( L - 1 ) \cdot B ( 1 ) + {\sum }_{i = 2}^{L - 1} {( - 1 )}^{i} B ( i - 2 ) \cdot B ( i ) \\ = 0 \qquad Eqs . ( 44 )$$

Summing the two equations together we have:

$$B ( L - 2 ) \cdot B ( 0 ) + {\sum }_{i = 1}^{2 k} B ( 2 i - 2 ) \cdot B ( 2 i ) = 0 \qquad Eq . ( 45 )$$

However, this result is clearly impossible since there are an odd number of terms on the left. By contradiction it is therefore shown that it is impossible to satisfy the constraints when L>2 for binary sequences.

### Noise Effects

The foregoing has demonstrated that distortions due to this spreading sequence design can be removed from the estimate of the communications channel impulse response. Attention is now turned to the remaining distortion caused by the additive noise. n(t) 121. Assuming that the noise source is white and stationary and is filtered by a receiver filter for bandwidth matching, its distortion measure can be defined as follows:

$$\begin{matrix}Δ = E [ \frac{1}{{t}_{2} - {t}_{1}} {\int }_{{t}_{1}}^{{t}_{2}} {\vert {\tilde{n}}_{M}^{′′} ( t ) \vert}^{2} ⅆ t ] & Eq , ( 46 ) \\ {\tilde{n}}_{M} = {\tilde{n}}_{M}^{′} ⊗ {f}^{{T}_{c}} & Eq . ( 47 ) \\ \begin{matrix}{\tilde{n}}_{M}^{′′} ( t ) = {\sum }_{l = - L}^{L} {\tilde{n}}_{M}^{′} ( t - {lT}_{c} ) \cdot f ( l ) \\ = \frac{1}{M} {\sum }_{l = - L}^{L} {\sum }_{m = 0}^{M - 1} {d}_{m} \cdot \tilde{n} ( t + {mNT}_{c} - {lT}_{c} ) \cdot f ( l ) \\ = \frac{1}{M} {\sum }_{l = - L}^{L} {\sum }_{m = 0}^{M - 1} {\sum }_{i} {d}_{m} \cdot n ( t + {mNT}_{c} + {iT}_{c} - {lT}_{c} ) \cdot S ( i ) \cdot f ( l ) \\ = \frac{1}{M} {{\sum }^{M - 1}}_{m = 0} {\sum }_{j} {d}_{m} \cdot n ( t + {mNT}_{c} + {jT}_{c} ) \cdot {R}_{fS} ( j )\end{matrix} & Eqs . ( 48 ) \\ where & \\ {R}_{fS} ( j ) = {\sum }_{l = - L}^{L} f ( l ) \cdot S ( l + j ) & Eq . ( 49 )\end{matrix}$$

The ensemble expectation of Eq. (46) can be taken over n(t), whose autocorrelation can be determined by the front end receive filter, and is assumed to be known).

$$\begin{matrix}\begin{matrix}{R}_{nn} ( τ ) = E [ {n}_{0}^{*} ( t ) \cdot {n}_{0} ( t + τ ) ] \\ Δ = \frac{1}{{M}^{2}} {\sum }_{{m}^{′} = 0}^{M - 1} {\sum }_{m = 0}^{M - 1} {\sum }_{{j}^{′}} {\sum }_{j} {d}_{m} \cdot {R}_{fS} ( j ) \cdot {R}_{nn} ( ( {m}^{′} - m ) {NT}_{c} + \\ ( {j}^{′} - j ) {T}_{c} ) \cdot {R}_{fS} ( {j}^{′} ) \cdot {d}_{m}^{′} \\ = {\sum }_{{j}^{′}} {\sum }_{j} {\overline{R}}_{fS}^{M} ( j ) \cdot {R}_{nn} ( ( {j}^{′} - j ) {T}_{c} ) \cdot {\overline{R}}_{fS}^{M} ( {j}^{′} )\end{matrix} & Eqs . ( 50 ) \\ {\overline{R}}_{fS}^{M} ( j ) = \frac{1}{M} {\sum }_{m = 0}^{M - 1} {d}_{m} \cdot {R}_{fS} ( j + mN ) & Eq . ( 51 )\end{matrix}$$

When the noise n(t) is white, we have:

$${R}_{nn} ( {kT}_{c} ) = 0 , ∀ k \neq 0 \\ Δ = {R}_{nn} ( 0 ) {\sum }_{j} {\vert {\overline{R}}_{fS}^{M} ( j ) \vert}^{2} \qquad Eq . ( 52 )$$

### EXAMPLES

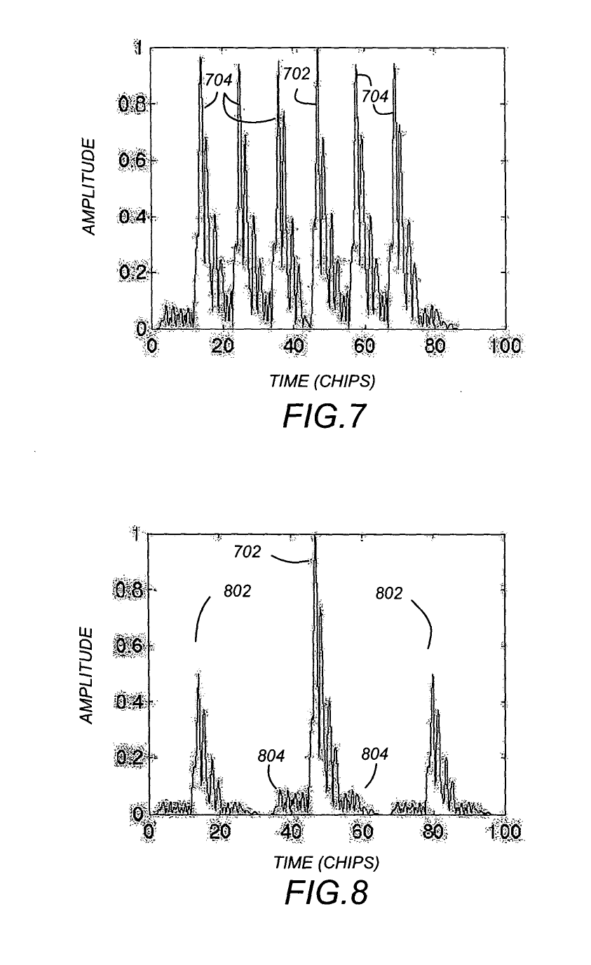

FIG. 7 through FIG. 10 are diagrams illustrating the performance improvements achieved by application of the present invention. These illustrated examples and places them, whereby a length 11 Barker code is used as the spreading sequence Sᵢ 104. FIGS. 7-10, normalized magnitudes as a function of chip timing. No adjustments were made for group delays introduced by correlation, filtering and windowing, therefore time coordinates should be treated in the relative sense. FIGS. 7-10 also do not include the effects of additive noise.

FIG. 7 is a diagram presenting a correlator 116 output using a length 11 Barker code and conventional communication channel impulse response estimation techniques. The correlator 116 output shows a main lobe peak 702, and multiple spurious peaks 704. These spurious peaks 704 (which are 11 chips, or NT_{c} seconds, apart due to the length 11 Barker code) are due to the repeated transmission of the short code Sᵢ 104, which are “aliased” back upon each other. If the length of the periodic spreading sequence Sᵢ 104 were longer, there would be fewer spurious peaks 704, and the peaks 704 would not overlap the main lobe peak 702 as much as is shown in FIG. 7.

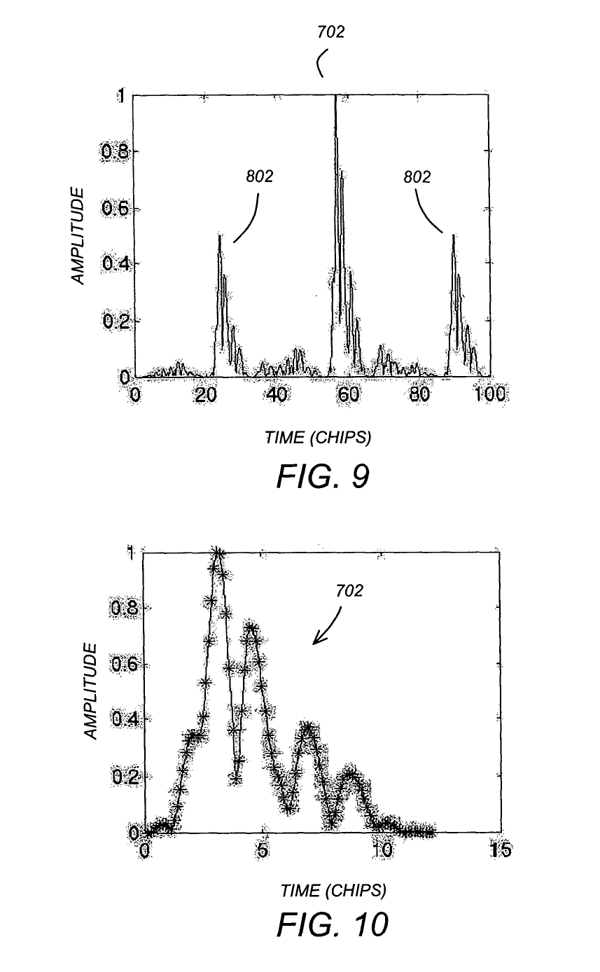

FIG. 8 is a diagram presenting a correlator 116 output using the Walsh codes in conjunction with the supercode technique described in FIG. 5. To generate this plot, the input data was constrained with two symbol-long Walsh codes w₀ and w₁, and the output was processed by summing two successive outputs of the correlator 116 as shown in Eq. (36). For the 11 chips on either side of the main lobe peak 702, there is zero correlation, and many of the spurious correlator peaks 704 that were apparent in FIG. 7 are no longer evident. Note, however that since only six bits of the data sequence are constrained . . . +,+,+,−,−,− . . . , some aliased versions of the main lobe peak 704 (labeled 802) are present (33 chips from the main lobe peak 702). However, since these aliased versions 802 are widely separated from the main lobe peak 702, an accurate estimate of the communications channel impulse response can be obtained. Note that a similar result can also be achieved without constraining the input sequence with the super code, but this would require integration over large number of symbols (e.g. M in Eq. (26) would be large). Note also that the main lobe peak 704 still includes minor peaks because the estimator 120 produces ĥ, which is a smeared version of h. These undesirable components 804, caused by the autocorrelation of the spreading sequence 104, cannot be removed by constraining the data sequence. Instead, these undesirable components 804 can be removed by filtering as described with respect to FIG. 9 below.

FIG. 9 is a diagram presenting a correlator 116 output shown in FIG. 8 after postprocessing with a filter f as described in FIGS. 2 and 3. Note that the sidelobes 802 shown in FIG. 8, have been pushed away from the main lobe peak 702, and some of the undesirable components 804 of the main lobe peak 702 have been filtered. Also note that the data indexing (the chips shown as the time axis) of FIG. 9 has changed relative to the data indexing of FIG. 8. As described above, this difference is an artifact of the software used to plot FIG. 7-FIG. 11 and is not associated with the applicant's invention.

FIG. 10 is a diagram presenting a more detailed view of the main lobe peak 702, showing the estimate of the communication channel impulse response (indicated by the asterisks) and the actual communication channel impulse response. Note that the estimated communication channel impulse response follows that of the actual response very closely.

### Hardware Environment

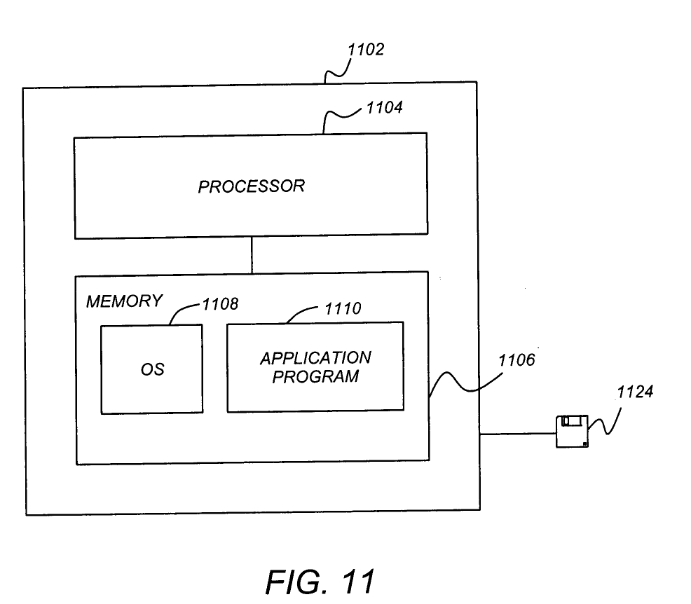

FIG. 11 and is a diagram illustrating an exemplary processor system 1102 that could be used in the implementation of selected elements of the present invention (including, for example, portions of the transmitter 110, the receiver 112, the correlator 116, the estimator 120, or the filter 302).

The processor system 1102 comprises a processor 1104 and a memory 1106, such as random access memory (RAM). Generally, the processor system 1102 operates under control of an operating system 1108 stored in the memory 1106. Under control of the operating system 1108, the processor system 1102 accepts input data and commands and provides output data. Typically, the instructions for performing such operations are also embodied in an application program 1110, which is also stored in the memory 1106. The processor system 1102 may be embodied in a microprocessor, a desktop computer, or any similar processing device.

Instructions implementing the operating system 1108, the application program 1110, and the compiler 1112 may be tangibly embodied in a computer-readable medium, e.g., data storage device 1124, which could include one or more fixed or removable data storage devices, such as a zip drive, floppy disc drive, hard drive, CD-ROM drive, tape drive, etc. Further, the operating system 1108 and the application program 1110 are comprised of instructions which, when read and executed by the computer 1102, causes the computer 1102 to perform the steps necessary to implement and/or use the present invention. Application program 1110 and/or operating instructions may also be tangibly embodied in memory 1106 and/or data communications devices 1130, thereby making an application program product or article of manufacture according to the invention. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present invention. For example, those skilled in the art will recognize that any combination of the above components, or any number of different components, peripherals, and other devices, may be used with the present invention. For example, an application-specific integrated circuit (ASIC) or a Field-Programmable Gate Array (FPGA) can be used to implement selected functions, including the correlator 116, and filtering functions can be performed by a general-purpose processor, as described above.

### CONCLUSION

This concludes the description of the preferred embodiments of the present invention. The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

1. A method of estimating a communication channel impulse response h(t), comprising the steps of:
generating coₘ(t)=co(t+mNT_{c}) for m=0, 1, Λ, M by correlating a received signal r(t) with a spreading sequence Sᵢ of length N, wherein the received signal r(t) comprises a chip sequence cⱼ applied to a communication channel characterizable by an impulse response h(t), and wherein the chip sequence cⱼ is generated from a data sequence dᵢ spread by the spreading sequence Sᵢ and wherein T_{c} is the chip period of the chip sequence cⱼ;
generating an estimated communication channel impulse response ĥ_{M}(t) as a combination of coₘ(t) and dₘ for m=0, 1, Λ, M; and
filtering the first estimated communication channel impulse response ĥ_{M}(t) to generate the estimated communication channel impulse response h(t) with a filter f selected at least in part according to the spreading sequence Sᵢ.

2. The method of claim 1, wherein the filter f is further selected at least in part according to an autocorrelation A(n) of the spreading sequence Sᵢ.

3. The method of claim 2, wherein the filter f is further selected at least in part according to the duration of the impulse response of the communication channel h(t).

4. The method of claim 2, wherein the filter f is further selected at least in part according to a zero-forcing criteria
$${\sum }_{i = - L}^{L} ( A ( n - i ) \cdot f ( i ) ) = {A}_{f} ( n ) , - L \leq n \leq L ,$$
wherein:
f(i) is the impulse response of the filter f such that A_{f}(n) is a convolution of A(n) and f(i);
A_{f} (n)=1 for n=0 and A_{f} (n)=0 for 0<|n|≦L; and
$$A ( n ) = A ( - n ) = {\sum }_{i = o}^{N - 1 - n} {S}_{i} \cdot {S}_{i + n} , 0 \leq n \leq N ,$$
and N is a length of the chip sequence Sᵢ.

5. The method of claim 4, wherein:
the parameter L is chosen such that a time duration of the impulse response of the communication channel h(t) is less than LT_{c}.

6. The method of claim 4, wherein:
the parameter L is chosen such that a time duration of the impulse response of the communication channel h(t) is approximately equal to LT_{c}.

7. The method of claim 1, wherein N is less than 20.

8. The method of claim 1, wherein M=0.

9. The method of claim 1, wherein the data sequence dᵢ includes a constrained portion Cdᵢ associated with at least two codes w₀, w₁, wherein a correlation A_{code}(k) of the constrained portion Cdᵢ with one of the codes w₀, w₁ is characterized by a maximum value at k=0 less than maximum values at k≠0.

10. The method of claim 9, wherein the step of generating an estimated communication channel impulse response ĥ_{M}(t) as a combination of coₘ(t) and dₘ for m=0, 1, Λ, M comprises the step of computing ĥ_{M}(t) as
$$\frac{1}{M} {\sum }_{m = 0}^{M - 1} {d}_{m} \cdot co ( t + {mNT}_{c} ) .$$

11. The method of claim 10, wherein M=2.

12. The method of claim 9, wherein the data sequence dᵢ includes a preamble having a pseudorandom code including the constrained portion of the data sequence dᵢ.

13. The method of claim 9, wherein A_{code}(k)=1 at k=0 and A_{code}(k)=0 for substantially all k≠0.

14. The method of claim 9, wherein A_{code}(k)=0 for 0<|k|≦J, wherein J is selected to minimize the correlation of the constrained portion Cdᵢ with the one of the codes w₀, w₁ for substantially all k≠0.

15. The method of claim 14, wherein 2J is a length of the constrained portion Cdᵢ.

16. The method of claim 1, wherein A_{code}(k)=1 at k=O and A_{code}(k)=0 for substantially all k≠0.

17. The method of claim 1, wherein each of the two codes w₀, w₁ comprises two symbols.

18. The method of claim 1, wherein the each of the two codes w₀, w₁ comprises no more than two symbols.

19. The method of claim 1, wherein the codes w₀, w₁ comprise Walsh codes.

20. An apparatus for estimating a communication channel impulse response h(t), comprising:
means for generating coₘ(t)=co(t+mNT_{c}) for m=0, 1, Λ, M by correlating a received signal r(t) with a spreading sequence Sᵢ of length N, wherein the received signal r(t) comprises a chip sequence cⱼ applied to a communication channel characterizable by an impulse response h(t), and wherein the chip sequence cⱼ is generated from a data sequence dᵢ spread by the spreading sequence Sᵢ and wherein T_{c} is the chip period of the chip sequence cⱼ;
means for generating an estimated communication channel impulse response ĥ_{M}(t) as a combination of coₘ(t) and dₘ for m=0, 1, Λ, M; and
a filter means f, selected at least in part according to the spreading sequence Sᵢ, the filter means for filtering the first estimated communication channel impulse response ĥ_{M}(t) to generate the estimated communication channel impulse response h(t) with

21. The apparatus of claim 20, wherein the filter means f is further selected at least in part according to an autocorrelation A(n) of the spreading sequence Sᵢ.

22. The apparatus of claim 21, wherein the filter means f is further selected at least in part according to the duration of the impulse response of the communication channel h(t).

23. The apparatus of claim 21, wherein the filter means f is further selected at least in part according to a zero-forcing criteria
$${\sum }_{i = - L}^{L} ( A ( n - i ) \cdot f ( i ) ) = {A}_{f} ( n ) , - L \leq n \leq L ,$$
wherein:
f (i) is the impulse response of the filter means f such that A_{f}(n) is a convolution of A(n) and f(i);
A_{f}(n)=1 for n=0 and A_{f}(n)=0 for 0<|n|≦L; and
$$A ( n ) = A ( - n ) = {\sum }_{i = o}^{N - 1 - n} {S}_{i} \cdot {S}_{i + n} , 0 \leq n \leq N ,$$
and N is a length of the chip sequence Sᵢ.

24. The apparatus of claim 23, wherein:
the parameter L is chosen such that a time duration of the impulse response of the communication channel h(t) is less than LT_{c}.

25. The apparatus of claim 23, wherein:
the parameter L is chosen such that a time duration of the impulse response of the communication channel h(t) is approximately equal to LT_{c}.

26. The apparatus of claim 20, wherein N is less than 20.

27. The apparatus of claim 20, wherein M=0.

28. The apparatus of claim 20, wherein the data sequence d, includes a constrained portion Cdᵢ associated with at least two codes w₀, w₁, wherein a correlation A_{code}(k) of the constrained portion Cdᵢ with one of the codes w₀, w₁ is characterized by a maximum value at k=0 less than maximum values at k≠0.

29. The apparatus of claim 28, wherein the means for generating an estimated communication channel impulse response ĥ_{M}(t) as a combination of coₘ(t) and dₘ for m=0, 1, Λ, M comprises means for computing ĥ_{M}(t) as
$$\frac{1}{M} {\sum }_{m = 0}^{M - 1} {d}_{m} \cdot co ( t + {mNT}_{c} ) .$$

30. The apparatus of claim 29, wherein M=2.

31. The apparatus of claim 28, wherein the data sequence dᵢ includes a preamble having a pseudorandom code including the constrained portion of the data sequence dᵢ.

32. The apparatus of claim 28, wherein A_{code}(k)=1 at k=0 and A_{code}(k)=0 for substantially all k≠0.

33. The apparatus of claim 28, wherein A_{code}(k)=0 for 0<|k|≦J, wherein J is selected to minimize the correlation of the constrained portion Cdᵢ with the one of the codes w₀w₁ for substantially all k≠0.

34. The apparatus of claim 33, wherein 2J is a length of the constrained portion Cdᵢ.

35. The apparatus of claim 20, wherein A_{code}(k)=1 at k=0 and A_{code}(k)=0 for substantially all k≠0.

36. The apparatus of claim 20, wherein each of the two codes w₀, w₁ comprises two symbols.

37. The apparatus of claim 20, wherein the each of the two codes w₀, w₁ comprises no more than two symbols.

38. The apparatus of claim 20, wherein the codes w₀, w₁ comprise Walsh codes.

39. An apparatus for estimating a communication channel impulse response h(t), comprising:
a correlator generating coₘ(t)=co(t+mNT_{c}) for m=0, 1, Λ, M by correlating a received signal r(t) with a spreading sequence Sᵢ of length N, wherein the received signal r(t) comprises a chip sequence cⱼ applied to a communication channel characterizable by an impulse response h(t), and wherein the chip sequence cⱼ is generated from a data sequence dᵢ spread by the spreading sequence Sᵢ and wherein T_{c} is the chip period of the chip sequence cⱼ;
an estimator for generating an estimated communication channel impulse response ĥ_{M}(t) as a combination of coₘ(t) and dₘ for m=0, 1, Λ, M; and
a filter f selected at least in part according to the spreading sequence Sᵢ, the filter for filtering the first estimated communication channel impulse response ĥ_{M}(t) to generate the estimated communication channel impulse response h(t).

40. The apparatus of claim 39, wherein the filter f is further selected at least in part according to an autocorrelation A(n) of the spreading sequence Sᵢ.

41. The apparatus of claim 40, wherein the filter f is further selected at least in part according to the duration of the impulse response of the communication channel h(t).

42. The apparatus of claim 40, wherein the filter f is further selected at least in part according to a zero-forcing criteria
$${\sum }_{i = - L}^{L} ( A ( n - i ) \cdot f ( i ) ) = {A}_{f} ( n ) , - L \leq n \leq L ,$$
wherein:
f(i) is the impulse response of the filter f such that A_{f}(n) is a convolution of A(n) and f(i);
A_{f}(n)=1 for n=0 and A_{f} (n)=0 for 0<|n|≦L; and
$$A ( n ) = A ( - n ) = {\sum }_{i = o}^{N - 1 - n} {S}_{i} \cdot {S}_{i + n} , 0 \leq n \leq N ,$$
and N is a length of the chip sequence Sᵢ.

43. The apparatus of claim 42, wherein:
the parameter L is chosen such that a time duration of the impulse response of the communication channel h(t) is less than LT_{c}.

44. The apparatus of claim 42, wherein:
the parameter L is chosen such that a time duration of the impulse response of the communication channel h(t) is approximately equal to LT_{c}.

45. The apparatus of claim 39, wherein N is less than 20.

46. The apparatus of claim 39, wherein M=0.

47. The apparatus of claim 39, wherein the data sequence dᵢ includes a constrained portion Cdᵢ associated with at least two codes w₀, w₁, wherein a correlation A_{code}(k) of the constrained portion Cdᵢ with one of the codes w₀, w₁, is characterized by a maximum value at k=0 less than maximum values at k≠0.

48. The apparatus of claim 47, wherein the estimator for generating an estimated communication channel impulse response ĥ_{M}(t) as a combination of coₘ(t) and dₘ for m=0, 1, Λ, M comprises means for computing ĥ_{M}(t) as
$$\frac{1}{M} {\sum }_{m = 0}^{M - 1} {d}_{m} \cdot co ( t + {mNT}_{c} ) .$$

49. The apparatus of claim 48, wherein M=2.

50. The apparatus of claim 47, wherein the data sequence d includes a preamble having a pseudorandom code including the constrained portion of the data sequence dᵢ.

51. The apparatus of claim 47, wherein A_{code}(k)=1 at k=0 and A_{code}(k)=0 for substantially all k≠0.

52. The apparatus of claim 47, wherein A_{code}(k)=0 for 0<|k|≦J, wherein J is selected to minimize the correlation of the constrained portion Cdᵢ with the one of the codes w₀, w₁ for substantially all k≠0.

53. The apparatus of claim 52, wherein 2J is a length of the constrained portion Cdᵢ.

54. The apparatus of claim 39, wherein A_{code}(k)=1 at k=O and A_{code}(k)=0 for substantially all k≠0.

55. The apparatus of claim 39, wherein each of the two codes w₀, w₁ comprises two symbols.

56. The apparatus of claim 39, wherein the each of the two codes w₀, w₁ comprises no more than two symbols.

57. The apparatus of claim 39, wherein the codes w₀, w₁ comprise Walsh codes.
